(19) United States
(12) Patent Application Publication
(10) Pub. No.: US 2015/0157024 A1
(43) Pub. Date: Jun. 11, 2015

(54) BIOCIDAL ALDEHYDE COMPOSITION FOR WATER MANAGEMENT

(71) Applicant: Howard Martin, Potomac, MD (US)

(72) Inventor: Howard Martin, Potomac, MD (US)

(21) Appl. No.: 14/605,487

(22) Filed: Jan. 26, 2015

Related U.S. Application Data
(63) Continuation-in-part of application No. 13/311,815, filed on Dec. 6, 2011, now Pat. No. 9,006,216.

(51) Int. Cl. A01N 57/20; A01N 35/04; C09K 8/60

(52) U.S. Cl. CPC A01N 57/20; C09K 8/605; A01N 35/04

(57) ABSTRACT

A combination biocide including OPA, quaternary phosphonium biocide (TTPC), alcohol (preferably isopropyl alcohol), and functional excipients for use in the oil and gas recovery industry or for vessel ballast water treatment. The functional excipients for the oil and gas recovery industry are an optional cellulose type proppant, a poloxamer wetting agent, a friction-reducing pluronic block copolymer, a drag reducing agent such as polyethylene oxide, and a flocculating agent. The proppant is unnecessary for vessel ballast water treatment. In both applications the OPA is the dialdehyde C₆H₄(CHO)₂ form. It will produce an inherent cidal effect and lower surface tension and thus aids in the spread of the TTPC on biofilm covered surfaces where it is readily absorbed by the negative surfaces of proteins and bacteria. It thus serves as a binding cidal agent between the TTPC and the application surface. The foregoing constituents are combined in preferred concentrations within acceptable ranges to provide a synergistic biological chemical complementarity system.

### CROSS-REFERENCE TO RELATED APPLICATION(S)

The present application is a continuation-in-part of U.S. patent application Ser. No. 13/311,815, filed Dec. 6, 2011, which derives priority from U.S. Provisional Patent Application Ser. No. 61/562,812, filed Nov. 22, 2011, and is a continuation-in-part of U.S. patent application Ser. No. 12/584,650, filed Sep. 9, 2009.

### BACKGROUND OF THE INVENTION

1. Field of the Invention

The present invention relates to chemical disinfection and sanitizing and, more particularly, to an improved biocidal aldehyde composition particularly suited for water management applications including secondary oil and gas recovery and ballast water treatment.

2. Description of the Background

To initiate oil and gas production in a shale recovery area, the oil and gas recovery industry commonly uses a technique known as hydraulic fracture, or “fracking.” Fracking is an oil well stimulation technique that uses the hydrodynamic shear of water pump pressure to create fractures that extend from an initially-drilled bore hole into the surrounding rock formations. The fractures are held open by a proppant (a propping agent), which is usually a granular substance such as sand, aluminum pellets or ceramic, which prevent the fractures from closing. Proppants are most often used in low permeability reservoirs and/or to re-stimulate production in old wells. Unfortunately, microbial contamination creates biofilms that clog these fractures. Surfaces of storage tanks, pipelines, water circulating systems, and machinery become colonized by biofilms over time. Biofilm harbors bacteria that attack surfaces such as steel, and that coalesce with oil in pipelines, causing pipeline blockage. Biofilm occurs naturally as a product of bacteria, fungi, algae, protozoa, etc., which develop it as a protective mechanism. Operators attempt treatment, penetration and removal of biofilm, and routinely use disinfectants to reduce microbial contamination to an innocuous level.

The basic strategy of biofilm control in the prior art is predicated on the use of chemicals to kill bacteria in the biofilm and to induce the natural sloughing of dead biofilm, thus cleaning the affected surface. Chemicals work against surface microorganisms existing in aqueous phase in a planktonic suspension, rather than in biofilm, because they are easy to kill. However, prior art chemical biocides do not effectively combat biofilm. Unlike surface microorganisms, the sessile organisms that produce biofilm are protected by an extracellular polymeric material which is not effectively eradicated by a purely chemical biocide. A purely chemical approach suffers from the limitation that the most effective antimicrobial agents do not penetrate the biofilm.

For example, it is known that the anionic polysaccharide matrix (glycocalyx) affords considerable protection to these biofilm-producing cells against antimicrobial agents. The mechanism for this protection is essentially akin to a physical barrier (the anionic polysaccharide matrix) erected against the penetration of the biocide. Along with this “barrier” other biological mechanisms are also involved, such as enzyme formation, reduction of metabolism through quiescence, and general stress response leading to a new general biofilm phenotype. This resistance of biofilm bacteria to biocides has been reported by several groups. Thus, the oil and gas industries have a severe biofouling problem caused by the development of biofilm along with sulfate reducing bacteria that creates significant damage.

It is thus very difficult to deliver enough of a cidal agent to destroy the bacteria within the biofilm: sessile organisms such as SRBs, algae, fungi, aerobic, anaerobic and facultative bacteria.

Another prior art treatment approach involves using the force of water pressure to control the biofilm by overcoming the tensile strength of the protective matrix material without damaging the integrity of the treated surface. However, this approach also suffers from inefficacy. These insidious and coated bacteria must be destroyed in order for water pipelines to function in oil and gas applications.

Without an effective biocide, microorganism growth leads to biofilm formation, which contributes to corrosion, contamination of oil and gas, and degradation of drilling muds and fracturing. There are a few existing commercial biocides that purport to solve the need. For example, Dow® sells a line of AQUCAR™ water treatment microbiocides which include various proportions of glutaraldehyde alone or in combination with other biocides such as acetone or ammonium chloride. Glutaraldehyde is an important high level disinfectant/sterilant also used in other industries such as the health care industry. It requires time and temperature control in order for it to be effective (residence time of 45-90 minutes for disinfection, and controlled temperature of from 20 C to 25-30 C). Glutaraldehyde also requires activation and dating to make it useful. Thus, proper usage entails a three step procedure and meticulous record-keeping regarding date of activation.

A different aldehyde, ortho-phthalaldehyde (OPA), has now come into use in the health care industry. Johnson and Johnson developed an original formulation in the late 1980s which is described in U.S. Pat. No. 4,851,449 and in subsequent continuation in part application(s). OPA has been approved by the FDA as a high level disinfectant with a twelve minute disinfection time at 20-22 degrees C. Its sterilization time is listed as between 24-32 hours. OPA interacts with amino acids and proteins of microorganisms. OPA is also lipophilic, which improves its uptake in the cell walls. Thus, OPA has been shown to be another effective disinfectant/sterilant. The J&J OPA concentration is 0.55% by weight at a pH 3-9. This formulation has been shown to be effective in a purely aqueous immersion solution.

Another company, Metrex Research Corp., continues to sell a modified formulation including OPA and referred to as OPA+, with an increased OPA concentration of 0.6% (0.05% more OPA), plus buffers, a corrosion inhibitor, and a chelating agent. In essence, the OPA+ formula is the same as the J&J product, with no faster kill time, but claims of 60% more treatment. However, OPA is not completely effective in clinical use at its concentration of 0.5% and pH 6.5, and failures of OPA solutions have been reported in literature surveys. An investigation of the mechanism by which OPA works reveals its weaknesses as a biocidal agent. The severe test for cidal effectiveness is the ability of a biocidal agent to kill gram negative bacteria, mycobacteria and spore-coated organisms. OPA is an aromatic dialdehyde. The benzene ring of OPA is a planar, rigid structure. Therefore, OPA has no flexibility as a result of steric hindrance. In addition, OPA only reacts with primary amines. For these reasons, the lipophilic aromatic component of OPA does not reliably penetrate the lipid-rich cell wall of mycobacteria and gram negative bacteria. OPA is bactericidal at low concentrations to staphylococci and gram negative bacteria. OPA exhibits poor cidal effectiveness against mycobacteria. Indeed, studies have shown that OPA exhibits selective bactericidal activity, showing good cidal activity against Pseudomonas aeruginosa, and limited cidal activity against mycobacterial strains. See Shackelford et al., Use of a New Alginate Film Test To Study The Bactericidal Efficacy Of The High-Level Disinfectant Ortho-Phthalaldehyde, Journal of Antimicrobial Chemotherapy, 57(2):335-338 (2006). OPA's poor sporicidal activity is thought to be due to low concentration and low pH. It has been noted that if the temperature of the treatment process is raised from the normal 20 degrees C. to 30 degrees C., OPA's biocidal characteristics improve. However, this temperature increase is impractical for most applications.

Despite these drawbacks, OPA has been suggested for use as a biocide in oil and gas recovery applications. For example, U.S. Pat. No. 5,128,051 to Theis et al., issued Jul. 7, 1992, discloses providing OPA to aqueous systems susceptible to biofouling, including secondary oil recovery processes.

Presently, there is no single universally effective biocide due to variable physical, chemical and biological parameters. A biocide must have interactions of a variegated nature in order to have a chance of reasonable effectiveness. What is needed is a simple and improved one-step formulation.

In U.S. Pat. No. 8,242,176, filed Sep. 9, 2009, the present inventor suggests a synergistic combination of quaternary ammonium cations (“quats”) with an aldehyde selected from the group consisting of glutaraldehyde and ortho-phthalaldehyde (OPA), isopropyl alcohol, a proppant comprising a cellulosic compound selected from the group consisting of methylcellulose, ethylcellulose and hydroxymethylcellulose, a pluronic block copolymer, a flocculating agent, and water. The disclosed formulation containing dual chain quaternary ammonium cations (“quats”) is shown to aid in the destruction, and prevent proliferation of, desulfovibrio desulfuricans (SRBs) present in injected water in oil and gas recovery applications. When injected, the quats spread through the subterranean sand structures containing residual oil and displace the oil in the direction of the producing well. However, the dual chain quat is a molecular solvent rather than a completely ionic solvent like tributyl tetradecyl phosphonium chloride (TTPC). Therefore the outcome reactions as between a dual chain quat and TTPC are different. The present inventor has established that a novel and unique combination of constituents in prescribed concentrations, including OPA, TTPC, isopropyl alcohol (IPA) and excipients provides a more effective biocidal formulation for aqueous addition to water resources, including fracturing water during secondary oil and gas recovery from a well. The OPA/IPA/TTPC formulation works in an evidenced-based synergistic manner to allow the OPA to be much more effective at room temperature.

Thus, the present application discloses an improvement to the prior art formulation in which a quaternary phosphonium salt, tributyl tetradecyl phosphonium chloride (TTPC), is substituted for the dual chain quaternary ammonium to achieve markedly improved biocidal results. The TTPC has improved thermal and chemical stability over the dual chain quaternary ammonium used in the prior formulation based upon its unique miscibility and solvating properties. TTPC is also less dense than water and is anion dependent, which makes it sensitive to various solutes and thereby a better component carrier for the glutaraldehyde, OPA, and IPA. It also enhances catalysis. TTPC is a phosphonium salt with the phosphonium ion (PH4+) replacing the amine of the dual chain quat formulation. The replaced quat of the prior formulation had a tendency to foam, especially above pH8. The mechanism of kill in the prior art formulation is cationic whereby an electrostatic bond is formed with the cell wall, affecting permeability and denaturing proteins. The effective pH of the herein disclosed formulation is 6-8.5 of and the mechanism of kill is only bacteriostatic.

TTPC is a broad spectrum biocide of the alkyl phosphonium group. Like the quat of the prior formulation, TTPC is cationic, but in contrast to the quat of the prior formulation, TTPC has a low foaming tendency, a high level of hydrolytic stability, and functions over a much broader pH range: from pH2-pH11. TTPC damages cell walls, as explained further, and affects cell enzyme process. TTPC also kills at much lower concentrations than the dual chain quat formulation and is faster acting. TTPC aids in biofilm penetration and delays biofilm regrowth, which is extremely meaningful for oil/gas usage. TTPC is a neoteric solvent/biocide that has been developed with remarkable individual properties. It is an ionic liquid that has microbicidal qualities, solvent qualities, and detergent qualities.

Importantly, TTPC is not affected by brine as is the dual chain quat formulation, thus making TTPC superior for oil field usage. The present invention may also be used for ballast water treatment which requirements are analogous to those of secondary oil and gas recovery. There are many harmful aquatic organisms and pathogens in the ballast water of ships. The inadvertent transfer of contaminated ballast water from region-to-region has had a significant adverse impact to many of the world's coastal regions. However, seawater contains brine which renders prior art antimicrobials for treatment, penetration and removal of biofilm in the oil and gas recovery process unsuitable. What is needed is an expedient way to treat a vessel's ballast water to prevent, minimize and possibly eliminate the risk to the environment, human health, property and natural resources arising from the transfer of such ballast water. The present composition is not affected by brine and is well-suited for ballast water treatment in addition to oil field usage.

### SUMMARY OF THE INVENTION

It is, therefore, an object of the present innovation to provide a novel biocidal formulation for aqueous addition to fracturing water during secondary oil and gas recovery from a well, and/or for aqueous addition to vessel ballast water, in both cases comprising orthophthalaldehyde (OPA) within a range of from 5-10% by weight (50K-100K ppm), tributyl tetradecyl phosphonium chloride (TTPC) within a range of from 5-10% by weight (50K-100K ppm), the relative amounts of said OPA and TTPC being within a range of from 2:1-to-1:2, and excipient constituents all mixed in an isopropyl alcohol solution (collectively, the “IPA/OPA/TTPC” formulation), the IPA/OPA/TTPC biocidal formulation being diluted to within a range of from 50 ppm to 1000 ppm prior to aqueous addition to said fracturing water or ballast water. The “IPA/OPA/TTPC” synergistic formulation combines cidal molecules with a biological chemical system that actively transports itself into the cells, through the biofilm and cell wall/membranes, thereby overcoming penetration restraints.

It is another object to improve cidal effectiveness against a broader range of refractory microorganisms within ecological and environmentally acceptable parameters, essentially yielding an ecologically friendly “green” biocide.

Thus, in one embodiment of the present invention, designed specifically for the oil and gas industry, these and other objects are accomplished by a novel biocidal formulation for aqueous addition to fracturing water during secondary oil and gas recovery from a well comprising orthophthalaldehyde (OPA) within a range of from 5-10% by weight, tributyl tetradecyl phosphonium chloride (TTPC) within a range of from 5-10% by weight, the relative concentration of OPA and TTPC being within a range of from 2/1-to-1/2, excipient constituents, a cellulosic proppant, and water, all mixed in an isopropyl alcohol solution (collectively, my “IPA/OPA/TTPC” formulation). The IPA/OPA/TTPC biocidal formulation is diluted to within a range of from 50 ppm to 1000 ppm prior to aqueous addition to the fracturing water. In another embodiment designed specifically for the ballast water treatment industry the very same IPA/OPA/TTPC biocidal formulation is used except without a proppant, and is likewise diluted to within a range of from 50 ppm to 1000 ppm prior to aqueous addition to the ballast water. These constituents in their prescribed concentrations form a novel and unique biological chemical system that actively transports itself into the cells, through the biofilm and cell wall/membranes, thereby overcoming penetration resistance. The combination of TTPC, OPA, IPA and excipients creates a unique and surprisingly more effective biocidal combination than the cationic amine based dual chain quats. The components together work in an evidenced-based synergistic manner to allow the OPA to be much more effective at the recited level of concentration and at room temperature, creating an outstanding synergistic interaction due to the new reactive chemistry of the ionic solvent, and improves kill effectiveness and kill time, without the need for activation or any time or temperature control.

Other objects, features, and advantages of the present invention will become more apparent from the following detailed description of the preferred embodiments and certain modifications thereof.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a graph demonstrating successful kill studies using the IPA/OPA/TTPC combination of the invention.

### DETAILED DESCRIPTION OF THE PREFERRED EMBODIMENT

The present invention is a solution with a synergistic complementarity of constituents that combine to improve the cidal effectiveness of ortho-phthalaldehyde (OPA) through a biological chemical system to provide improved results. Thus, in accordance with the present invention, two core biocides OPA and Tributyltetradecylphosphonium Chloride (TTPC) are combined with isopropyl alcohol (IPA) in alcohol-solution form, and other functional excipients selected specifically for use in the oil and gas recovery industry, as described in greater detail below, to form an ideal biocidal frac water and/or ballast water additive for use in the oil and gas recovery industry and shipping industry, respectively.

This unique chemo-biological formulation improves the cidal effectiveness of the OPA by the addition TTPC in relative concentrations ranging from 2:1 to 1:2. The foregoing are mixed in an aqueous solution with isopropyl alcohol (IPA), and excipient constituents including a friction reducing chemical additive triethanol amine, a wetting agent glycol ether, a drag reducing agent sulfonic acid, a flocculating agent Polyox™, water, and optional proppant (for oil and gas recovery). The aqueous solution has a pH within a range of from 3 to 9. The biocidal formulation is diluted to within a range of from 50 ppm to 1000 ppm upon aqueous addition to the fracturing water and/or ballast water, and upon such addition the foregoing combination creating a synergistic and unexpected improvement in biocidal effectiveness resulting in faster kill time.

The substitution of TTPC for the dual chain quat in the formulation of the present invention results in different thermodynamics and kinetics, and improved synergism and killing. The biocidal results of the present formulation are 2-to-4 times greater than with the quat-based formulation, and toxicity is also reduced. According to the presently-disclosed formulation OPA plus TTPC works in synergy to kill the SRBs more effectively. The formulation of the present invention avoids the problems experienced with prior art biocidal formulations by utilizing a biochemical approach, rather than a purely chemical one, to attack and kill biofilm bacteria much more effectively than those biocidal formulations disclosed in the prior art. Moreover, in the industrial context, the efficacy of the present formulation improves as the temperature rises. While the majority of the tests comprising the examples disclosed herein were run at 20-22 C, tests run at 25-30 C showed a significant reduction in kill time.

The friction reducing chemical additive of choice is a monomeric polymer, most preferably a pluronic block copolymer. Aqueous solutions of block copolymers are stable, soluble and exist as monomolecular micelles. They decrease surface tension as well as surface free energy. They reduce proppant flowback by strengthening the molecular structure of the cellulose comprising the proppant due to their inherent adhesiveness, which also aids in agglomeration of the proppant.

The wetting agent of choice facilitates the deep penetration of the frac and/or ballast water by reducing frictional drag coefficients. For this application, a high velocity, hydro miscible agent such as a poloxamer is preferred. Poloxamers are nonionic triblock copolymers composed of a central hydrophobic chain of polyoxypropylene (poly(propylene oxide)) flanked by two hydrophilic chains of polyoxyethylene (poly(ethylene oxide)).

The hydrodynamic flow may also be increased by improving flowability and penetration, thereby enhancing the shear forces. To achieve this, a drag reducing agent such as polyethylene oxide may be used. What is required of the drag reducer is an agent that has a low coefficient of friction, and low film thickness. In addition, the preferred drag reducer is thixotropic or rheopectic. The preferred drag reducing agent should also be effective at either low or high velocity for frac fluid usage. An agent having a fixed film thickness and low compressibility is also necessary due to the constant loading experienced by the frac water. Thus, the most preferred drag reducing agent is a water soluble resin such as a nonionic, high molecular weight water-soluble poly(ethylene oxide) polymer that brings lubricity, water retention, film formation and thickening into play. Dow® Polyox™ is the preferred brand of polyethylene oxide for the drag reducing agent of the present application, as it shows low degradation at high pressure turbulence and is also compatible with the TTPCs used by the formula according to the present invention. The addition of this agent enables frac fluid to transport itself and penetrate deep into fractures. A reduction of splattering viscoelasticity is also necessary, and Polyox™ is an ideal flocculating agent for this purpose.

When used for oil and gas recovery an optional proppant may be included. The optional proppant is biodegradable and will not clog or block the fluid from entering and exiting the formation. Additionally, to enhance recovery, the fracking technique is used with what is known as a “slick water frac.” A “slick water frac” requires the addition of a friction reducing chemical additive to allow water to be pumped faster and deeper into the formation. Therefore, the oil and gas recovery industry is best served by a formulation that contains a biocide, a biodegradable proppant, and a soluble friction reducer as an additive to the pressurized liquid (“fracking water” or “frac water”) that is pumped into the well. The above-described formulation may be modified slightly to provide an unconventional formula approach to this problem.

The proppant of choice is a cellulose type, preferably a water soluble binder such as methylcellulose, ethylcellulose or hydroxymethylcellulose, which serves as an inactive filler, thickener and stabilizer. These materials are hydrophilic and highly absorbent, thereby making an excellent proppant of a purely biologic, non-toxic nature. Due to its biodegradability and natural occurrence, this type of proppant also has a low or negligible impact on the surrounding ecosystem and environment into which the frac water is injected. The preferred proppant is a straight chain polymer that behaves like an extended stiff rod or micro fibril with high tensile strength. This structure occurs when the hydroxyl group on the glucose molecule combines with oxygen molecules through hydrogen bond thus giving shape, form and strength to the chemical compound. In warm environments, methylcellulose is a preferred because heat solidifies it, thus giving it a heartier form and substance. Methylcellulose is also a good choice because of its inherent lubricity and the fact that its derivatives can aid in water retention, increase surface slip resistance and maintain open time. A particular form of methylcellulose, microcrystalline cellulose, also compacts well under high pressures and has a high binding capacity. It is hard, stable and yet can disintegrate rapidly. Cellulose is thus a preferred proppant excipient for oil and gas recovery applications.

Preferably, the core OPA, TTPC, isopropyl alcohol and functional excipients are combined in the following preferred concentrations within acceptable ranges:

| | Percentage (%) | |
|---|---|---|
| | by Weight/ | Acceptable |
| Constituent | ppm (Preferred) | Range |
| OPA | 5% (50K ppm) | 5-10% (50K-100K ppm) |
| TTPC | 5% (50K ppm) | 5-10% (50K-100K ppm) |
| Isopropyl alcohol | 41% | 10-60% |
| Methylcellulose, | 0.4% | 0.2-0.5% by weight |
| ethylcellulose or | | |
| hydroxymethylcellulose | | |
| Pluronic block | 0.7% (7000 ppm) | 0.01-3% by weight (100- |
| copolymer | | 30,000 ppm) |
| Poly(ethylene oxide) | 5000 ppm or 0.5% | 1000-10,000 ppm or 0.1- |
| (Polyox ™) | by weight | 1% by weight |

The balance of the solution includes excipient additives including Triethanol Amine, Glycol Ether, and Sulfonic Acid. The pH range throughout can be pH 3 to pH 9.

The biocidal formulation is diluted to within a range of from 50 ppm to 1000 ppm upon aqueous addition to the fracturing and/or ballast water. The water used for the formulation according to the present invention may be water in any available form, including water from a well onsite, running water provided by the municipality in which the site resides or pumped in by other means, or water carried to the site, such as, for oil and gas recovery operations, water carried onboard an oil tanker in a ballast tank or other compartment.

The following examples illustrate the efficacy of the above-described embodiment in a formulation without the addition of a proppant, friction reducing chemical additive, wetting agent, drag reducing agent, or flocculating agent:

### Example 1

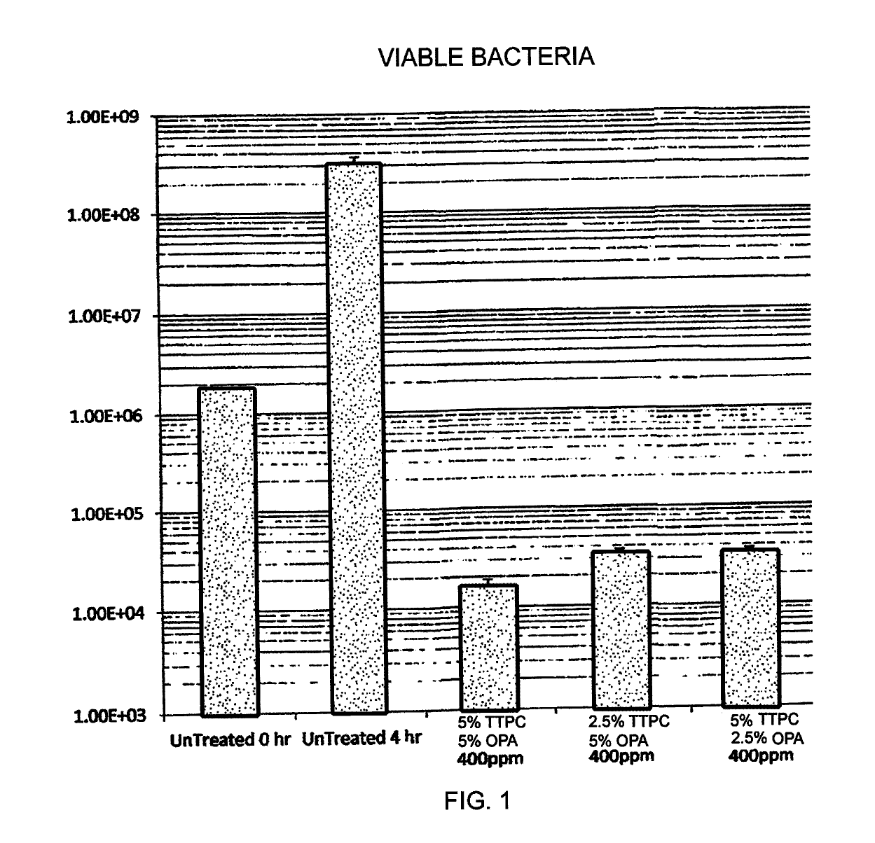

FIG. 1 demonstrates successful kill studies using the IPA/OPA/TTPC combination. Column 3 shows a 5% OPA, 5% TTPC, and 1/1 TTPC/OPA combination. Column 4 shows a 5% OPA, 2.5% TTPC, and 1/2 TTPC/OPA combination, and Column 5 shows a 2.5% OPA, 5% TTPC, and 1/2 TTPC/OPA combination. The resulting log reductions in the bacterial strains surpasses Champion's Bactron® biocides, evidencing synergy in my IPA/OPA/TTPC formulation as claimed. All tests were independently-conducted using a standard MBEC™ testing protocol, and verifies a 99.999% kill, three times faster, and only a 5% bioburden. This shows an effectively superior synergistic combination versus the prior art.

Similarly, the TTPC/OPA formulation reduced the effective kill time of acid-producing bacteria (APB) by almost 50%. The TTPC/OPA combinations tested also performed better than OPA alone as a biocidal agent. Moreover, in this example, testing revealed that the best biocidal activity occurred with formulations comprising an OPA/TTPC ratio of between 1:2 and 2:1, and preferably 1:1 OPA/TTPC. Specifically, one formulation containing 3.125 ppm OPA and 6.25 ppm TTPC, and another formulation containing 6.25 ppm OPA and 3.125 ppm TTPC, were tested against both APBs and SRBs. Formulations containing (1) OPA as a lone biocidal agent at a concentration of 12.5 ppm, and (2) TTPC as a lone biocidal agent, also at a concentration of 12.5 ppm, were tested under the same conditions. Cidal efficacy of the 2:1 and 1:2 OPA/TTPC combinations was greater than for either of these biocides alone. Efficacy against APBs was similar to that against SRBs, with both combinations showing complete kill at one hour with less total active biocidal agents (9.375 ppm of total biocidal agent for the combination OPA/TTPC formulations) than formulations containing higher biocidal concentrations (12 ppm) of OPA or TTPC alone.

### Example 2

Another test with the organism of Pseudomonas aeruginosa was carried out using a suspension of 10⁴ bacteria/ml with 5% serum added as bioburden. The suspension was exposed to TTPC/OPA/IPA in concentrations of 50 ppm, 100 ppm, 500 ppm, and 1,000 ppm for periods of 4 hours, 1 hour, and 30 minutes. The results showed complete kill in all time frames and at all concentrations. This test was repeated at bacterial concentrations of 10⁵/ml and 10⁶/ml. The results were similar, illustrating that the increased concentration of bacteria did not require titration of the biocide. The effective range of bactericidal activity for incorporation of TTPC within the OPA materials was thus from 50 ppm to 1,000 ppm.

### Example 3

Isopropyl alcohol (IPA) and quaternary ammonium kill Pseudomonas at a concentration of 10⁶ bacteria/mL in 2 min with concentrations of 0.24% quat and 41.5% IPA. This was compared to a mixture of 18% IPA and 0.10% TTPC at 2 minutes with 10⁶/ml of Pseudomonas. The kill effectiveness was measured at 0 failures in 60 tubes. This again shows the unusual strength of synergy of TTPC with the various tested biocides. The IPA was an important additive as this formulation has a high volatile organic compound (VOC) issue. By reducing the alcohol and TTPC levels, the present formulation will fall within more healthy parameters.

As a result of the foregoing cidal effects, the synergy index was between 0.6 and 0.8 (below 1.0 indicates synergy effectiveness) for the various combinations of chemistries. This illustrates a notably-significant improvement in bactericidal effectiveness and synergy over the formulations disclosed by the prior art.

Comparing the OPA/quaternary ammonium formulation to the OPA/TTPC/IPA formulation of the present invention, the rate of kill was faster for the present formulation by 1 log in 30 min even though the concentration of TTPC was 50% less than the concentration of the quat amine in the prior formulation. Thus, beyond improved cidal results, the present formulation demonstrates improved ecological results in the oilfield context because a lower concentration of chemicals may be used with similar or increased cidal effectiveness. The OPA/quat formulation of the prior art versus the OPA/TTPC formulation of the present invention reacted in similar fashion during testing. However, based on the experimental results described above, in the present formulation, both glut and OPA components can be reduced by 10% overall, and the TTPC (versus quaternary ammonium component) can be reduced by 50%. Thus, the presently disclosed formulation is a safer, more ecological biocide for both oil/gas recovery and ballast water treatment.

TTPC is also less volatile than quaternary ammonium, thereby reducing the release of VOCs. Thus, as described above, the present formulation is a tailored solvent micro biocide that optimizes cidal effectiveness as well as decreases ecological toxicity. The formulation also exhibits more stable thermal conditions, remaining liquid in a range of 300 C (−96 to 200 C), working in a pH range of 2-12, succeeding in solvating organic, inorganic and polymeric materials, catalyzing, and exhibiting very miscible behavior in the present solution.

As described with particularity above, in the particular context of biofilm reduction in secondary oil and gas recovery or ballast water management where brine is an issue, TTPC has superior biofilm removability compared to quaternary ammonium. As such, there is actually a slight increase in the types of planktonic microbes that are susceptible to the biocidal effects of the present formulation versus prior art formulations. Individual biocides affect the physiology of the cell quite differently. Understanding and capitalizing on their effects allows for a more intelligent (safe and effective) and innovative combination of mechanistically different agents so that a more effective and efficient formulated compound is developed. The present combination of chemicals creates an improved general synergy of action resulting in a more efficient and targeted application of a biocide mixture rather than multiple single biocides, surprisingly and significantly adding to the synergistic effectiveness of the biocidal combinations of TTPC with ortho-phthalaldehyde, and isopropyl alcohol, separately in individual formulation. This is an example of enhanced quantum complementarity.

The importance of the environmental parameter cannot be understated based upon the foregoing results. TTPC has a similar margin of exposure as the quats for oil field imputability with friction reducers for killing of aerobic organisms. However, TTPC is twice as effective as the original glut/quat formula and improves the OPA/quat blend based upon a 5 log reduction in oil frac water. Moreover, the instant OPA/TTPC blend, diluted to 1,000 ppm, is essentially non-corrosive to metals including stainless steel, making it safe for well and tank treatment, as the minimum inhibitory concentration (MIC) for TTPC usage is 50-500 ppm.

The faster cidal action of the present formulation is due to the chemistry difference between amine quats and phosphonium salts. In tests involving the prior art formulations, the ammonium quat did not kill all the test bacteria in the allotted time of 30 minutes. The present formulation did, due to the differences explained herein. Compared to phosphonium salts, ammonium quats have longer alkyl chains. A longer chain length was traditionally considered superior for biocidal applications. However, the present invention demonstrates that there is an optimal chain length for anti-bacterial effectiveness. Moreover, the present invention also demonstrates that attachment moieties are a factor in anti-bacterial effectiveness, and that the addition of a phosphonium ion instead of an amine increases anti-bacterial effectiveness. The unexpected results found with the present formulation include the fact that the tetradecyl group exhibited the broadest spectrum of activity against the tested microorganisms, including MRSA, B. subtillis (which are gram+), E coli, pseudomonas aeruginosa (gram−), and candida a fungus, based upon specific chain length.

This is also due in part to an understanding of the differences between the cell walls of Gram+ and Gram− bacteria. Gram+ possess a mesh-like wall of peptidoglycan and teichoic acid. The Gram− wall is complicated; in addition to the mesh-like wall of a Gram+ bacteria, Gram− bacteria have an outer membrane of lipopolysaccharides and phospholipids that protect the cell, referred to as the S layer, which adheres to the outer cell membrane and has a tile-like pattern associated with the peptidoglycan layer. The S layer is susceptible to ion formation and osmotic stress. By attacking this layer the self-assembly ability of cell protection is reduced. This disrupts the glycocalyx (both the capsule and slime/biofilm layer) of the cell.

In addition, capsules held outside the cell wall are polysaccharides. As such, they contain a great deal of water and protect the cell against hydrophobic biocides. However, TTPC is amphiphilic—or both hydrophobic and hydrophilic. This also helps to explain the increased cidal activity of TTPC. Interestingly, and unexpectedly, TTPC is unusually suited for attacking phospholipid membrane proteins, which themselves are amphiphilic. These membrane proteins are of two types—peripheral (easily disrupted) and integral (not so easily disrupted). Integral proteins are essential for cell function. Because it is amphipathic, TTPC is unusually effective at disrupting these membranes as a biocidal agent.

The length of the biocide alkyl chain creates a hydrophobic tail. By adjusting the chain as in TTPC, it becomes able to interact with the cytoplasm membrane, the target site of cationic biocides. However, unlike cationic biocides, TTPC was shown by the present inventor to be effective with a somewhat shorter chain length, contrary to expectations. For biocidal effectiveness, the ability of a chemical to rupture the membrane cell wall and gain access to the cytoplasmic membrane is key. The ability of an aldehyde to rupture a cell membrane is a function of critical micelle concentration (CMC), which in turn is a function of alkyl chain length. The rearrangement of the molecular cell wall to form a channel space with enough radius to allow access of the OPA, and IPA, all in combination with TTPC, to the interior of the cell requires sufficient rupturing. Disruption is more effective at lower surface tensions, also a function of CMC, and bending rigidity weakening based upon negative bubble curvature, as described in the hole-nucleation theory of Kabalnov and Wennerstrom (Langmuir, 1996). Porin proteins may then form trimers in the cell's outer membrane, creating tube-like water filled channels through which TTPC may pass to access the inner cytoplasmic membrane, which is made of phospholipids and proteins (phosphoglycerides) similar to Gram+ as well as Gram-cells. The TTPC of the present formulation can thus react easily and at a lower concentration (in ppm) than the quat amines, while also carrying the other cidal components, such as the OPA and IPA, along with it into the cell interior.

Consequently, TTPC as a quat replacement works via a different mechanism of action, and improves synergy with OPA and IPA. This leads to reduced microbial resistance and rebound, and decreased environmental toxicity due to using much lower concentrations of all of the chemical components described herein. Another added benefit is the lower cost allowed due to the reduced amounts of each chemical needed to create the formulation described herein. From a practical viewpoint, the use of synergistic combinations of TTPC and the aforementioned biocides to inhibit bacterial growth is suitable for reduction in biocide use while being as effective as higher concentrated biocides. As such, the addition of TTPC, in lieu of quaternary ammonium, aids in the active sustainability of the biocide process. Therefore, reactions may be carried out in various types of media, can have enhanced reaction rates, higher yields and unconventional selective reactions.

One last interesting yet obscure issue is that of inadvertent nutrient introduction by OPA that will add greater than 50 mg/l of organic carbon to the media over time. In general, biocides naturally degrade over time, ultimately falling below their MIC, but added carbon will fuel regrowth of the microbes. Quats do not affect this phenomenon, but TTPC does. Unexpectedly, TTPC aids rapid kill and accelerates removal of the necrotic remnants, reducing the remaining bacteria to very low levels prior to biocide degradation, so that the chance of regrowth is greatly diminished.

A dual biocide approach is extremely important because it minimizes the risk of resistant organisms developing, as well as being more effective against recalcitrant organisms. The unique combinations disclosed herein offer a better opportunity for biofilm slime penetration and dispersion, thereby effecting superior cellular penetration and enabling an effective cidal dosing at lower minimum kill concentration levels. It allows for multiple options of kill pathways rather than a single option, as is typically available for single biocides or even dual biocides of related natures. That is the importance of the formulated synergistic effect of cidal biochemical relationships between different chemistries and unusual components.

The above-described addition of a friction reducing chemical additive, wetting agent, drag reducing agent, and flocculating agent to the core formulation is well-suited for ballast water treatment in the shipping industry, combining biocidal molecules in a synergistic biological chemical system that actively transports itself into the cells, through biofilm and cell wall/membranes, thereby overcoming penetration restraints to improve kill effectiveness and kill time, without the need for activation or any time or temperature control. This is an effective example of synergistic complementarity.

The above-described addition of a proppant is well-suited for hydraulic fracture or “Tracking” to initiate oil and gas production in the shale recovery area.

Although the preferred embodiment uses TTPC in combination with ortho-phthalaldehyde, isopropanol, and chlorine dioxide, one skilled in the art should readily understand that another suitable phosphonium salt might be used in place of TTPC to achieve comparable results. For example, an equal amount of tetrakis (hydroxymethyl) phosphonium sulfate (THPS) may be substituted for TTPC in the above-described formulations.

Having now fully set forth the preferred embodiment, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A biocidal formulation for aqueous addition to fracturing water during secondary oil and gas recovery from a well, comprising orthophthalaldehyde within a range of from 5-10% by weight, plus tributyl tetradecyl phosphonium chloride (TTPC) within a range of from 5-10% by weight, the relative amounts of said orthophthalaldehyde and TTPC being within a range of from 2:1-to-1:2, plus excipient constituents including a friction-reducing agent, a drag reducing agent, a flocculating agent, and water, all mixed in an isopropyl alcohol solution having a pH within a range of from 3 to 9;
wherein said biocidal formulation is diluted to within a range of from 50 ppm to 1000 ppm prior to aqueous addition to said fracturing water.

2. The biocidal formulation of claim 1, wherein said friction-reducing agent comprises triethanol amine.

3. The biocidal formulation of claim 1, wherein said drag reducing agent comprises glycol ether.

4. The biocidal formulation of claim 1, wherein said flocculating agent comprises sulfonic acid.

5. The biocidal formulation of claim 1, further comprising a cellulosic proppant selected from the group consisting of methylcellulose, ethylcellulose and hydroxyethylcellulose, and said excipient constituents consist of a pluronic block copolymer, a flocculating agent, and said water.

6. The biocidal formulation of claim 1, wherein said isopropyl alcohol is within a range of from 15% to 41%.

7. A biocidal formulation for aqueous addition to vessel ballast water, comprising orthophthalaldehyde within a range of from 5-10% by weight, plus tributyl tetradecyl phosphonium chloride (TTPC) within a range of from 5-10% by weight, the relative amounts of said orthophthalaldehyde and TTPC being within a range of from 2:1-to-1:2, plus excipient constituents including a friction-reducing agent, a drag reducing agent, a flocculating agent, and water, all mixed in an isopropyl alcohol solution having a pH within a range of from 3 to 9;
wherein said biocidal formulation is diluted to within a range of from 50 ppm to 1000 ppm prior to aqueous addition to said vessel ballast water.

8. The biocidal formulation of claim 7, wherein said friction-reducing agent comprises triethanol amine.

9. The biocidal formulation of claim 7, wherein said drag reducing agent comprises glycol ether.

10. The biocidal formulation of claim 7, wherein said flocculating agent comprises sulfonic acid.

11. The biocidal formulation of claim 7, wherein said isopropyl alcohol is within a range of from 15% to 41%.

12. A method for treatment of fracturing water during secondary oil and gas recovery from a well, comprising the steps of:
mixing a biocidal formulation comprising orthophthalaldehyde within a range of from 5-10% by weight, plus tributyl tetradecyl phosphonium chloride (TTPC) within a range of from 5-10% by weight, the relative amounts of said orthophthalaldehyde and TTPC being within a range of from 2:1-to-1:2, plus excipient constituents including a friction-reducing agent, a drag reducing agent, a flocculating agent, and water, in a solution having a pH within a range of from 3 to 9;
diluting said mixed biocidal formulation to within a range of from 50 ppm to 1000 ppm;
adding said mixed diluter biocidal formulation to said fracturing water.

13. A method for treatment of vessel ballast water, comprising the steps of:
mixing a biocidal formulation comprising orthophthalaldehyde within a range of from 5-10% by weight, plus tributyl tetradecyl phosphonium chloride (TTPC) within a range of from 5-10% by weight, the relative amounts of said orthophthalaldehyde and TTPC being within a range of from 2:1-to-1:2, plus excipient constituents including a friction-reducing agent, a drag reducing agent, a flocculating agent, and water, in a solution having a pH within a range of from 3 to 9;
diluting said mixed biocidal formulation to within a range of from 50 ppm to 1000 ppm;
adding said mixed diluter biocidal formulation to a ballast water tank of a vessel.
